(19) United States
(12) Patent Application Publication
(10) Pub. No.: US 2005/0278284 A1
(43) Pub. Date: Dec. 15, 2005

(54) System and method for accelerating service processor

(75) Inventors: Adger Erik Harvin III, Raleigh, NC (US); Rajiv N. Kantesaia, Cary, NC (US); Joseph Kinman Lee, Raleigh, NC (US)

Correspondence Address: IBM CORPORATION, PO BOX 12195, DEPT YXSA, BLDG 002, RESEARCH TRIANGLE PARK, NC, 27709, US

(73) Assignee: International Business Machines Corporation, Armonk, NY (US)

(21) Appl. No.: 10/862,087

(22) Filed: Jun. 4, 2004

(51) Int. Cl. G06F 7/00

(52) U.S. Cl. 707/1

(57) ABSTRACT

A service processor that manages a server farm includes a data compare engine that accelerates service processor operation by comparing a current data report from a server to a previous report and noting the changes between the reports, so that only the changes need be analyzed, instead of the entire report.

### FIELD OF THE INVENTION

The present invention relates generally to service processors.

### BACKGROUND

Service processors are used to manage a group (colloquially referred to as a “farm”) of server computers. This is because modern computer systems have grown sufficiently complex that secondary service processors are used to provide initialization of the computer systems, component synchronization and, in some cases, startup assistance to components that do not completely self-initialize. The functions of a service processor can also include, for example, monitoring the work of the servers, recording hardware errors, performing operator initiated manual actions (such as starting and stopping the servers), and recovering after errors. Some service processors are connected to external networks such as local area networks (LANs) or wide area networks (WANs) so that a remote administrator may operate the service processor and, hence, the server farm.

With particular regard to supervisory and error recovery operation, such operation may be undertaken using a Joint Test Action Group (JTAG) interface, the details of which are defined by IEEE (Institute of Electrical and Electronics Engineers) standard 1149.1—IEEE Standard Test Access Port and Boundary Scan Architecture. Regardless of the interface used, as recognized herein reports from servers to the service processor may include a great deal of data that the service processor must analyze to determine the status of the servers. As further recognized herein, the speed with which such analysis is conducted can be critical. A delay of only a few seconds in responding to the failure of a server, for example, could mean the loss of an important credit card transaction being processed by the failing server before the service processor is able to transfer the transaction to another server in the farm. Having recognized the need for speed in a service processor, the present invention has been provided.

### SUMMARY OF THE INVENTION

A service processor-implemented method includes receiving data from a server in a group of servers. Each server includes its own processor. The method includes comparing the new data to corresponding previous data from the server to identify which new data, if any, is different from the previous data. Based on the comparing act, at least some of the new data that is different from the previous data is analyzed. In non-limiting implementations the method can include analyzing only new data that has changed from the previous data and not analyzing any of the new data that has not changed from the previous data.

The comparing step may include establishing bits in a compare result vector data structure (such as a compare engine result vector array) indicating which data in the new data is changed from corresponding data in the previous data. The compare result vector data structure can then be accessed to analyze only the changed data. Further, the method can include generating primary status bits indicating no difference between the new data and previous data, a single difference between the new data and previous data, or more than a single difference between the new data and previous data. The primary status bits can likewise be accessed to analyze only the changed data. The primary status bits can be stored in a primary status data structure that can also contain bits indicating which portions of the compare result vector data structure contains new data that has changed from the corresponding previous data. Further, the primary status data structure can contain bits indicating the locations in the compare result vector data structure of first and, if any, last bits of new data that has changed from the corresponding previous data. In addition to the primary data structure, an auxiliary status data structure can be provided that has bits representing bytes in the compare result vector data structure which indicate new data that has changed from the corresponding previous data.

In another aspect, a service processor system includes an analysis engine and a compare engine that is accessible to the analysis engine. In accordance with the present invention, the compare engine generates indications of what parts of data from a server have changed since data was previously reported by the server, with the analysis engine using the indications to analyze only changed parts of the data.

In still another aspect, a system with plural servers includes a service processor communicating with the servers and receiving data therefrom. The service processor includes means for analyzing changed data in new data from the servers, and means for identifying the changed data on the basis of corresponding previous data from the server.

The details of the present invention, both as to its structure and operation, can best be understood in reference to the accompanying drawings, in which like reference numerals refer to like parts, and in which:

### BRIEF DESCRIPTION OF THE DRAWINGS

FIG. 1 is a block diagram of the present architecture;

FIG. 2 is a block diagram of the comparator module of the service processor;

FIG. 3 is a schematic diagram of the element descriptor and compare data descriptor received by the compare engine;

FIG. 4 is a schematic diagram of the compare engine result vector register;

FIG. 5 is a schematic diagram of the primary status register;

FIG. 6 is a schematic diagram of the auxiliary status register; and

FIG. 7 is a flow chart showing how the analysis engine uses the output of the compare engine to efficiently analyze data from the servers in the server farm.

### DETAILED DESCRIPTION OF THE PREFERRED EMBODIMENT

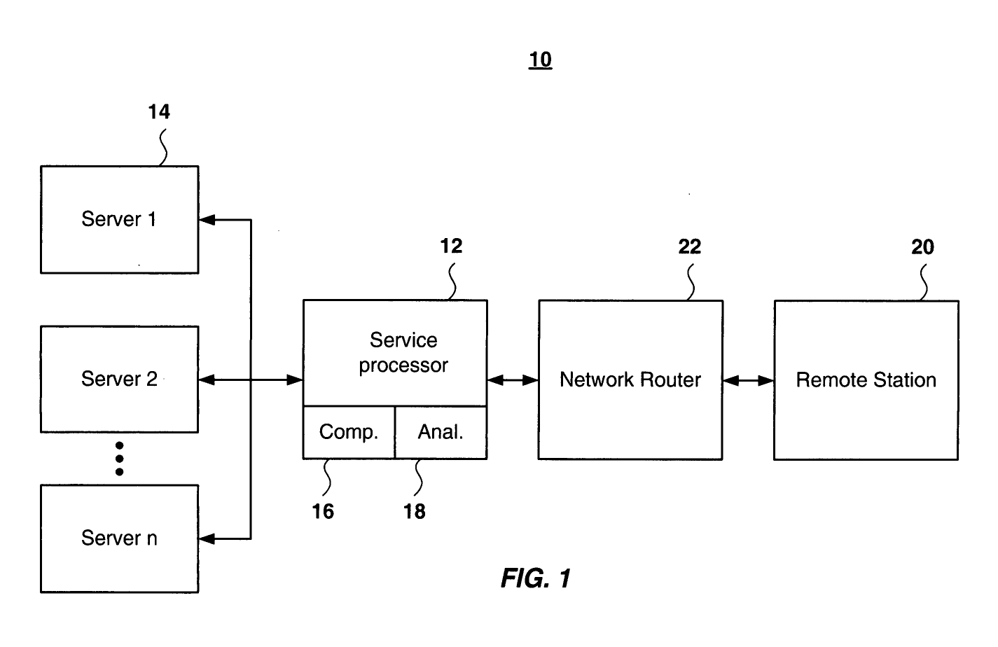

Referring initially to FIG. 1, a computing system is shown, generally designated 10, that includes a service processor 12 which manages plural servers 14 in a server farm in accordance with service processor principles known in the art. The service processor 12 and servers 14 can be any suitable computers, e.g., a personal computer or larger systems, a laptop computer, a notebook computer or smaller systems, etc. In any case, the service processor 12 and servers 14 each include their own respective central processing units, storage, etc.

FIG. 1 shows that the service processor 12 also has a comparator module 16 and an analysis engine 18 for undertaking the present invention. The module 16 and engine 18 may be implemented in firmware or software that executes the logic herein. The logic may be embodied as computer code on an electronic data storage medium such as but not limited to a magnetic or optical disk (e.g., floppy diskette, hard disk drive, CD or DVD) or solid state memory which in turn establishes a computer program product. Additionally, the service processor 12 may communicate with a remote administrator computer station 20 through a network router 22 over, e.g., the Internet. It is to be understood that a remote display session of the comparator module 16 and analysis engine 18 may be implemented and displayed in the remote station 20.

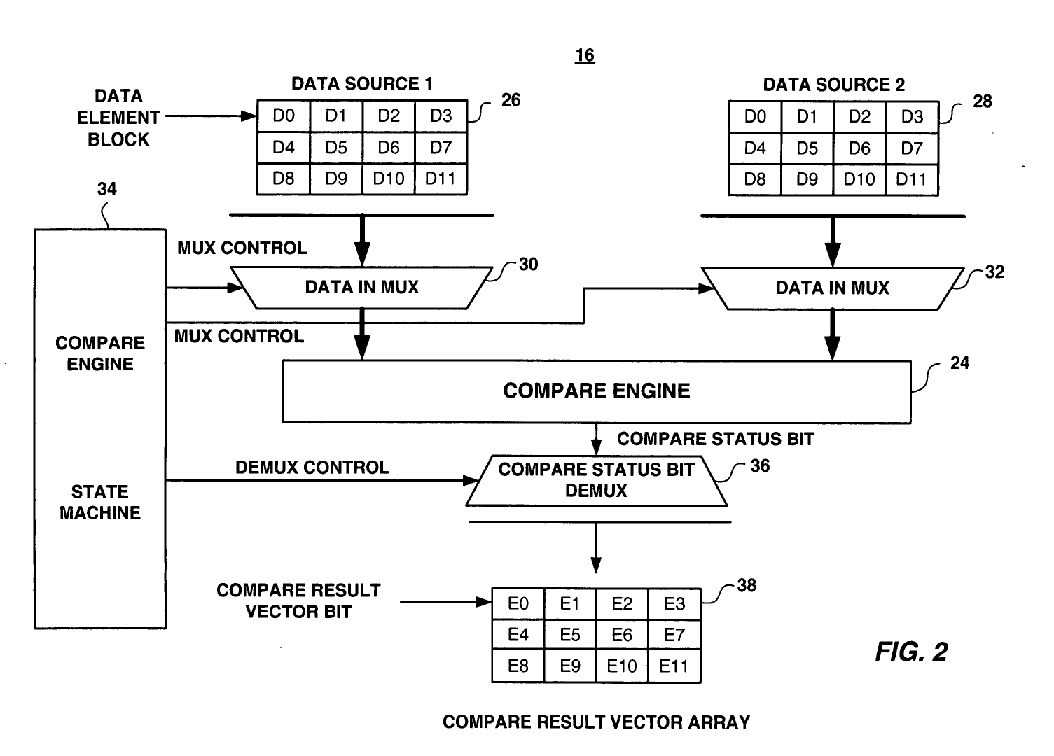

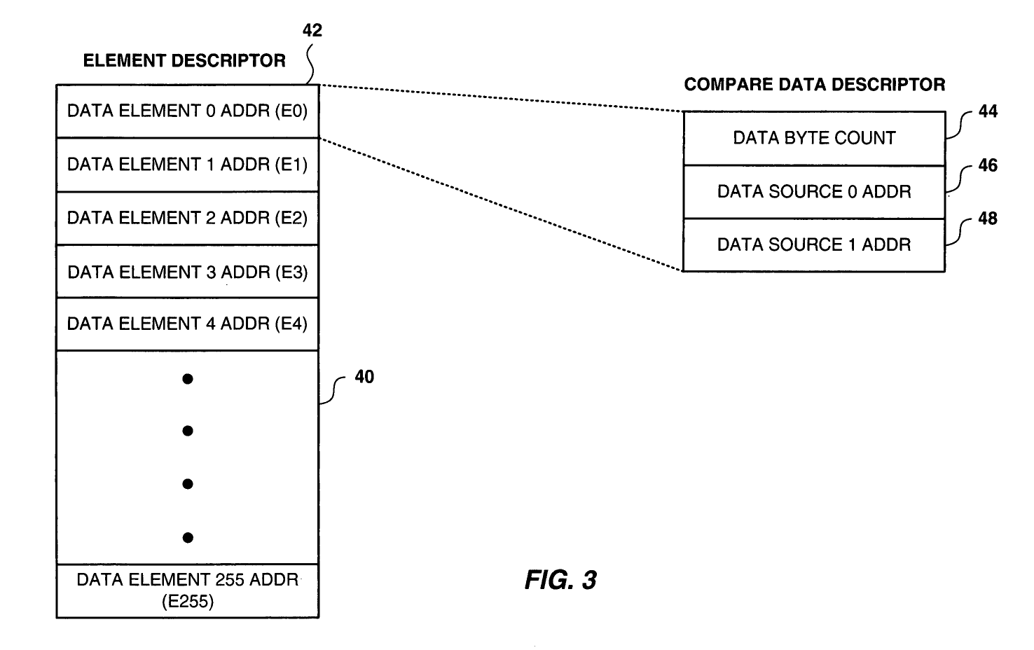

Now referring to FIG. 2, one firmware implementation of the comparator module 16 may be seen, it being understood that the components shown may alternatively be embodied in software. As shown, a compare engine 24 receives data from first and second data sources 26, 28 (also referred to herein as a source 26 and target 28) through respective data multiplexers 30, 32. The data conceptually may be arranged in tables or matrices of data element blocks D0, . . . ,D(n) as shown, although preferably it is arranged as shown in FIG. 3 and discussed further below. The first data source 26 may be new data representing a current state of one of the servers 14 shown in FIG. 1, and the second data source 28 may be previous data representing the previous state of the same server. The server may send both new and previous data or the new data may be received from the server with the previous data being retrieved from the memory or storage of the service processor 12. In any case, it may now be appreciated that each data element block Dᵢ (in the blocks D0, . . . ,D(n)) of the first data source 26 (e.g., a new data element) represents the same information (albeit with potentially different bit values) as its corresponding block Dᵢ in the second data source 28 (e.g., a previous data element). As mentioned above, this correspondence can be facilitated by use of the non-limiting exemplary element descriptor discussed below in reference to FIG. 3. The multiplexers 30, 32 may be controlled by compare engine state machine 34 that feeds into the compare engine 24 a data element Dᵢ from the first data source 26 followed by a data element Dᵢ from the second data source 28 for comparison of the two elements in accordance with principles below.

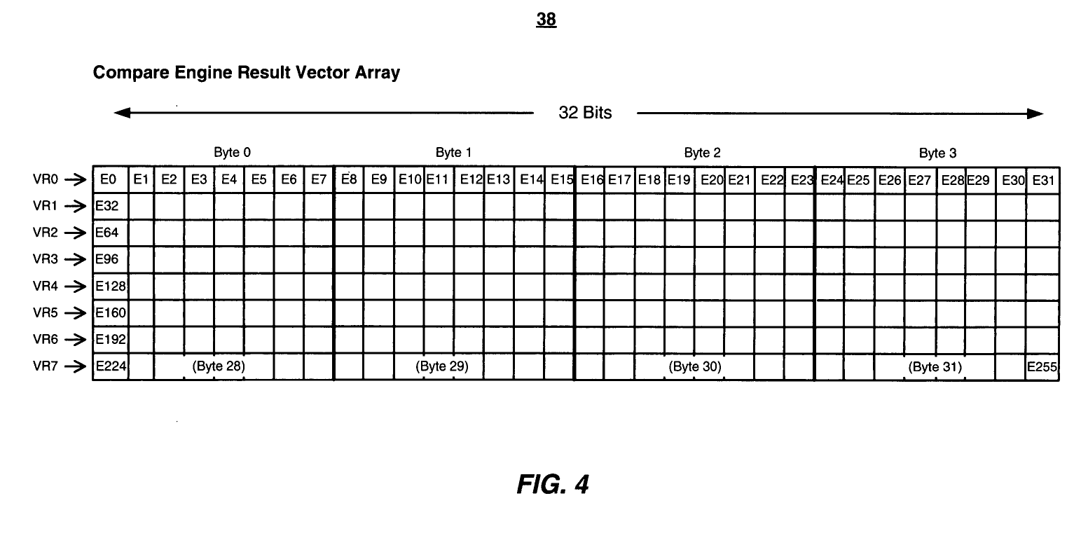

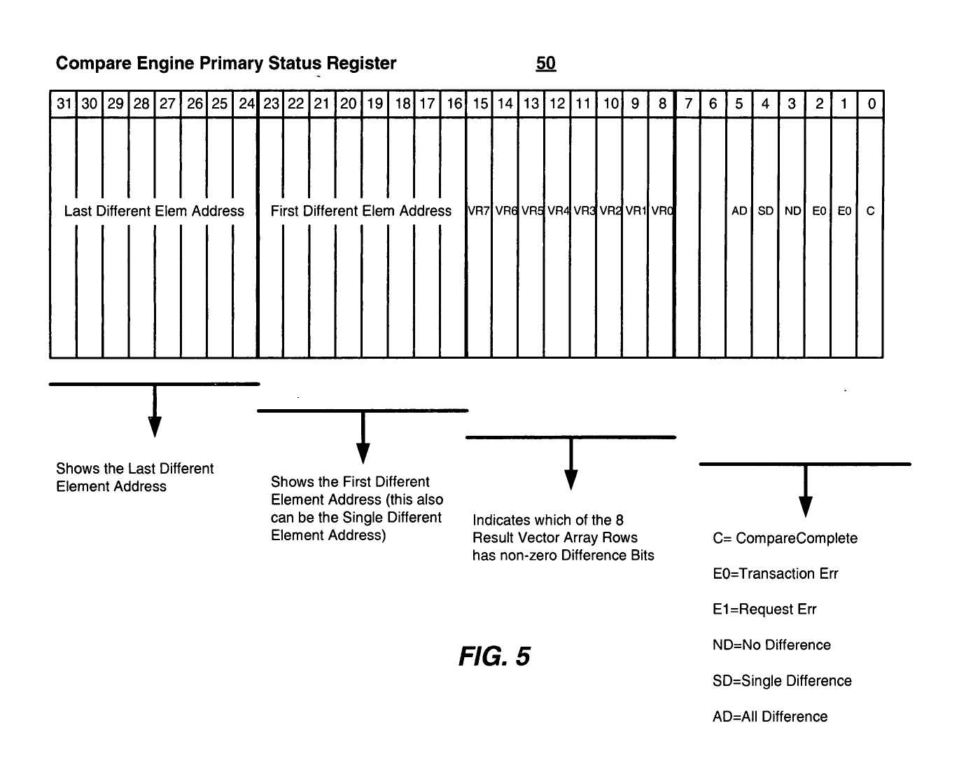

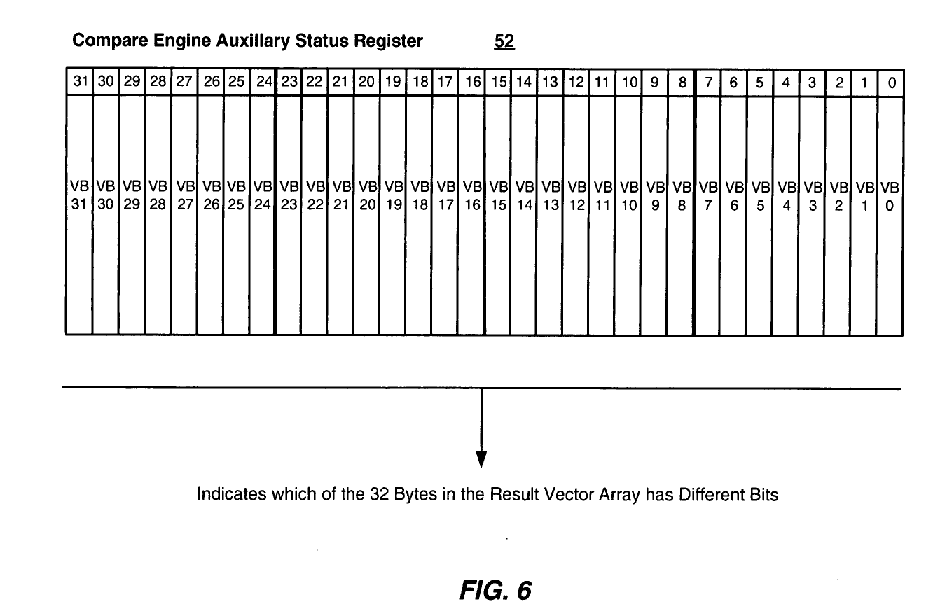

FIG. 2 shows that the state machine 34 also provides demultiplexing control to a compare status bit demultiplexer 36, which receives from the compare engine 24 a bit indicating the result of the comparison between the two data elements, e.g., a one can indicate a change and a zero can indicate no change. The demultiplexer 36 fills a compare result vector data structure such as an array 38, shown and described further below in reference to FIG. 4, with the compare status bits from the demultiplexer 36. In addition, the compare engine 24 also sets the bits in the data structures described below in reference to FIGS. 5 and 6.

FIG. 3 shows that an element descriptor 40 which is generated by the data sources 26, 28 or by the comparator module 16 can represent the data in the two sources 26, 28 and can be used by the state machine 34 to locate the data from the sources 26, 28. As shown, the element descriptor 40 includes plural (e.g., 256) element address pointer sets 42. Each element address pointer set 42 contains an address that has three fields, one field to a data byte count 44 (the number of bytes in the data) and two more fields to the respective addresses of each data element in the source and target 26, 28 shown in FIG. 2. In a non-limiting embodiment the data byte count 44 field can support data sizes up to a megabyte, although smaller or larger sizes are contemplated herein. Using the non-limiting data structures shown in FIG. 3, the compare engine 24 shown in FIG. 2 can compare two data blocks of data up to the data byte count size. While one comparison is being made, the next elements to be compared may be simultaneously fetched.

FIG. 4 shows details of the compare engine result vector array 38 shown in FIG. 2, it being understood that while an array is shown for illustration other data structures containing the output of the compare engine 24 may be used. In the non-limiting exemplary embodiment shown, the compare engine result vector array 38 contains 256 element compare result bits organized in eight rows of thirty two bits each as generated by the compare engine 24 in FIG. 2. In one hardware implementation the bits can be implemented using eight vector registers, labelled VR0-VR7 in FIG. 4, each of which contains thirty two bits and, thus four eight bit bytes labelled ByteO-Byte 3.

As mentioned above, the compare engine 24 sets primary status bits in a primary status data structure, implemented in one embodiment as a primary status register 50 shown in FIG. 5. In one implementation, bits 0-5 of the register 50 (shown as being the right-most bits in FIG. 5) are set, one or zero, as appropriate to establish the primary status bits themselves. The values of the primary status bits indicate the following results of the comparison performed by the compare engine 24 in FIG. 2 relative to the compare engine result vector array 38 shown in FIG. 4: “all different” (meaning that all elements in the compare engine result vector array 38 are set to indicate differences between the data sources 26, 28; this is reflected in the primary status register 50 by setting, in the example shown, bit 5); “single difference” (meaning only a single element in the compare engine results vector array 38 indicates a difference between data sources; this could be indicated in the primary status register 50 by setting, in the example shown, bit 4); “no difference” (indicating that no difference exists between the data source elements represented by the compare engine result vector array 38; may be reflected by setting, in the example of the primary status register 50 shown, bit 3); “error” (bits 1 and 2); and “compare complete” (bit 0).

FIG. 5 also shows that bits 8 to 15 are set, one or zero, as appropriate to indicate which, if any, of the eight bytes of the compare engine result vector array 38 indicate differences between data sources, e.g., which if any of the bytes of the compare engine result vector array 38 have values of one. The upper two bytes of the primary status register 50 (i.e., bits 16-23 and 24-31) respectively indicate the addresses of the first and last difference elements in the case wherein a string of positive difference elements exists in the compare engine result vector array 38. For the single difference case, both the first difference element address and last difference element address indicate the address of the single difference; for the no difference case, a default zero address is indicated; and for the case wherein a localized region of differences exists, both the first difference element address and last difference element address are indicated.

In accordance with a non-limiting exemplary implementation, the bits within each byte in the compare engine result vector array 38 are ORed together to establish a single status-byte difference bit indicating whether the associated row in the compare engine result vector array 38 has any difference status-bits. Thus, each compare engine result vector array 38 is the source for thirty two status-byte difference bits, and these status-byte difference bits are stored in an auxiliary data structure such as the compare engine auxiliary status register 52 shown in FIG. 6. The skilled artisan will appreciate that each bit in the auxiliary status register 52 indicates whether its associated byte in the compare engine result vector array 38 has a bit indicating a difference.

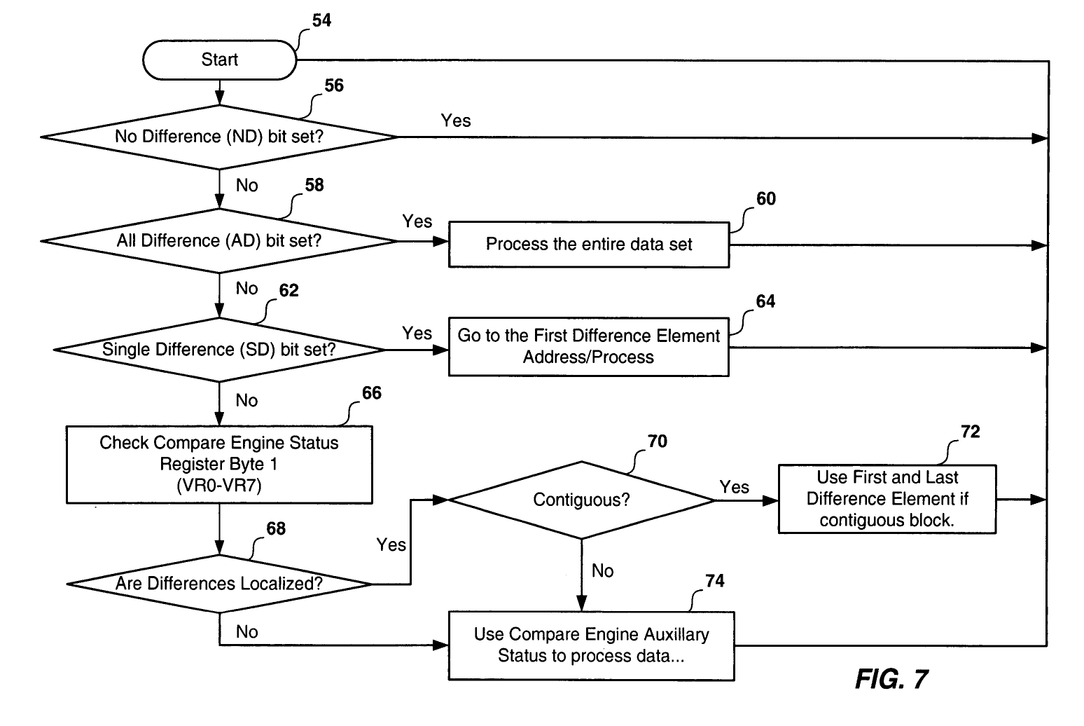

With the above data structures that are generated by the comparator module 16, the analysis engine 18 can execute the logic shown in FIG. 7 to quickly analyze only that data from the servers 14 which have changed since the prior data report. The logic for analyzing the data represented by a compare engine result vector array 38 starts at state 54 and flows to decision diamond 56, wherein it is determined whether the “no difference” bit is set in the primary status register 50. If so, the logic ends for that compare engine result vector array 38 and loops back to state 54 to analyze the next compare engine result vector array. On the other hand, if any differences exist the logic proceeds to decision diamond 58 to determine whether the “all differences” bit is set in the primary status register 50. If the “all differences” bit is set, all new data from the associated server 14 that is represented by the compare engine result vector array 38 under test is analyzed by the analysis engine 18 at block 60, and then the logic loops back to state 54 for the next compare engine result vector array.

As shown in FIG. 7, a negative test result at decision diamond 58 causes the logic to flow to decision diamond 62 to determine whether the “single difference” bit is set in the primary status register 50. If it is set, the logic moves to block 64 to obtain, from the primary status register 50, the address of the first (and in this case, only) difference element in the compare engine result vector array 38 and to use that address to retrieve the underlying changed data element from the new data received from the associated server 14. Thus, only the single changed data element need be analyzed.

If none of the difference bits at decision diamonds 56, 58, and 62 are found to be set, the logic proceeds to block 66 to check bits 8-15 of the primary status register 50 to determine which bits in the compare engine result vector array 38 indicate changes. At block 68 it is determined whether the changes are localized to a few elements. If so, the logic moves to decision diamond 70 to determine whether the localized changes are contiguous to each other. If they are, the process flows to block 72 to use the first and last addresses from the two left-most bytes in the primary status register 50 to determine the sequence of addresses of the compare engine result vector array 38 indicating changes. Only the underlying changed data reflected by the changed elements in the compare engine result vector array 38 need be analyzed.

On the other hand, if the changes are not localized or if they are not contiguous, the analysis engine 16 accesses the auxiliary status register 52 shown in FIG. 6 to obtain the byte locations in the compare engine result vector array 38 representing changed data. Only the underlying changed data is then analyzed.

While the particular SYSTEM AND METHOD FOR ACCELERATING SERVICE PROCESSOR as herein shown and described in detail is fully capable of attaining the above-described objects of the invention, it is to be understood that it is the presently preferred embodiment of the present invention and is thus representative of the subject matter which is broadly contemplated by the present invention, that the scope of the present invention fully encompasses other embodiments which may become obvious to those skilled in the art, and that the scope of the present invention is accordingly to be limited by nothing other than the appended claims, in which reference to an element in the singular is not intended to mean “one and only one” unless explicitly so stated, but rather “one or more”. It is not necessary for a device or method to address each and every problem sought to be solved by the present invention, for it to be encompassed by the present claims. Furthermore, no element, component, or method step in the present disclosure is intended to be dedicated to the public regardless of whether the element, component, or method step is explicitly recited in the claims. No claim element herein is to be construed under the provisions of 35 U.S.C. §112, sixth paragraph, unless the element is expressly recited using the phrase “means for” or, in the case of a method claim, the element is recited as a “step” instead of an “act”. Absent express definitions herein, claim terms are to be given all ordinary and accustomed meanings that are not irreconcilable with the present specification and file history.

1. A service processor-implemented method comprising the acts of:
receiving data from a server in a group of servers;
comparing the new data to corresponding previous data from the server to identify which new data, if any, is different from the previous data; and
based on the comparing act, analyzing at least some of the new data that is different from the previous data.

2. The method of claim 1, wherein the comparing act is undertaking by using an element descriptor including plural element address sets, each element address set containing an address having three fields, one field to a data byte count and two more fields to respective addresses of each data element in a source containing the previous data and a target containing the new data.

3. The method of claim 1, comprising analyzing only new data that has changed from the previous data and not analyzing any of the new data that has not changed from the previous data.

4. The method of claim 1, wherein the comparing act comprises accessing a compare result data structure with bits indicating which data in the new data is changed from corresponding data in the previous data, the compare result data structure being accessible to execute the analyzing act.

5. The method of claim 4, wherein the comparing act comprises establishing primary status bits indicating no difference between the new data and previous data, a single difference between the new data and previous data, or more than a single difference between the new data and previous data, the primary status bits being accessible to execute the analyzing act.

6. The method of claim 5, wherein the primary status bits are stored in a primary status data structure accessible to execute the analyzing act, the primary status data structure also containing bits indicating which portions of the compare result data structure contains new data that has changed from the corresponding previous data.

7. The method of claim 6, wherein the primary status data structure also contains status-bits indicating the locations in the compare result data structure of first and, if any, last elements of new data that has changed from the corresponding previous data.

8. The method of claim 7, wherein an auxiliary status data structure includes bits representing status-bytes in the compare result data structure containing new data that has changed from the corresponding previous data, the auxiliary status data structure being accessible to execute the analyzing act.

9. The method of claim 8, wherein the data structures are implemented as registers.

10. A service processor system, comprising:
an analysis engine; and
a compare engine accessible to the analysis engine, the compare engine generating indications of what parts of data from a server have changed since data was previously reported by the server, the analysis engine using the indications to analyze only changed parts of the data.

11. The service processor system of claim 10, wherein the service processor system analyzes data from plural servers in a server farm.

12. The service processor system of claim 10, wherein the compare engine establishes bits in a compare result data structure indicating which data in new data is changed from corresponding data in previous data, the compare result data structure being accessible to the analysis engine.

13. The service processor system of claim 12, wherein the compare engine generates primary status bits indicating no difference between the new data and previous data, a single difference between the new data and previous data, or more than a single difference between the new data and previous data, the primary status bits being accessible to the analysis engine.

14. The service processor system of claim 13, wherein the primary status bits are stored in a primary status data structure accessible to the analysis engine, the primary status data structure also containing bits indicating which portions of the compare result data structure contains new data that has changed from the corresponding previous data.

15. The service processor system of claim 14, wherein the primary status data structure also contains bits indicating the locations in the compare result data structure of first and, if any, last elements of new data that has changed from the corresponding previous data.

16. The service processor system of claim 15, wherein the compare engine accesses an auxiliary status data structure to establish bits representing each status byte in the compare result data structure containing new data that has changed from the corresponding previous data, the auxiliary status data structure being accessible to the analysis engine.

17. The service processor system of claim 16, wherein the data structures are implemented as registers.

18. The service processor system of claim 10, wherein the compare engine uses at least one element descriptor including plural element address sets, each element address set containing an address having three fields, one field to a data byte count and two more fields to respective addresses of each data element in a source containing the previous data and a target containing the new data.

19. A system, comprising:
plural servers;
at least one service processor communicating with the servers and receiving data therefrom, the service processor including:
means for identifying changed data in new data from the servers on the basis of corresponding previous data from the server, for analysis of only the changed data by a means for analyzing.

20. The system of claim 19, wherein the means for identifying accesses a compare result data structure to establish bits indicating which data in the new data is changed from corresponding data in previous data, the compare result data structure being accessible to the means for analyzing.

21. The system of claim 20, wherein the means for identifying generates primary status bits indicating no difference between the new data and previous data, a single difference between the new data and previous data, or more than a single difference between the new data and previous data, the primary status bits being accessible to the means for analyzing.

22. The system of claim 21, wherein the primary status bits are stored in a primary status data structure accessible to the means for analyzing, the primary status data structure also containing bits indicating which portions of the compare result data structure contains new data that has changed from the corresponding previous data.

23. The system of claim 22, wherein the primary status data structure also contains bits indicating the locations in the compare result data structure of first and, if any, last elements of new data that has changed from the corresponding previous data.

24. The system of claim 19, wherein the means for identifying accesses an auxiliary status data structure to establish bits representing bytes in the compare result data structure containing new data that has changed from the corresponding previous data, the auxiliary status data structure being accessible to the means for analyzing.

25. The system of claim 23, wherein the data structures are implemented as registers.

26. The system of claim 19, wherein the means for identifying accesses at least one element descriptor including plural element address sets, each element address set containing an address having three fields, one field to a data byte count and two more fields to respective addresses of each data element in a source containing the previous data and a target containing the new data.
